(19) United States
(12) Patent Application Publication
(10) Pub. No.: US 2025/0139970 A1
(43) Pub. Date: May 1, 2025

(54) DETECTING A MISSED EVENT WHEN MONITORING A VIDEO WITH COMPUTER VISION AT A LOW FRAME RATE

(71) Applicant: KEPLER VISION TECHNOLOGIES B.V., Amsterdam (NL)

(72) Inventors: Marc Jean Baptist VAN OLDENBORGH, Amsterdam (NL); Fares ALNAJAR, Amsterdam (NL)

(73) Assignee: KEPLER VISION TECHNOLOGIES B.V., Amsterdam (NL)

(21) Appl. No.: 18/835,970

(22) PCT Filed: Feb. 4, 2023
(86) PCT No.: PCT/EP2023/052748

§ 371 Date: Aug. 5, 2024

(30) Foreign Application Priority Data
Feb. 4, 2022 (EP) 22155293.8
Apr. 8, 2022 (EP) 22167281.9

(51) Int. Cl. G06V 20/40; G06V 10/82; G06V 10/98; G06V 20/52

(52) U.S. Cl. CPC G06V 20/44; G06V 10/98; G06V 10/82; G06V 20/52

(57) ABSTRACT

The invention provides event detection method for detecting a detail event in a time sequence of images having a main frame rate, the method comprising:
receiving a time slice of the time sequence of images;
storing in a memory a first set of images from the time slice at a first frame rate which is equal to or lower than the main frame rate;
providing a first inference engine comprising a first trained machine learning model which is trained for detecting a trigger event in an input comprising at least one image;
providing a second inference engine comprising a second trained machine learning model which is trained for detecting the detail event in an input comprising at least one image;
processing a second set of images from the time slice at a second frame rate which is lower than the first frame rate, by providing at least one image of the second set of images as input to the first inference engine for detecting the trigger event in the second set of images;
upon detection of the trigger event in the second set of images, processing the first set of images from the memory by providing at least one image of the first set of images as input to the second inference engine for detecting the detail event.

### FIELD OF THE INVENTION

The invention relates to detecting an event in a sequence of images, and in particular though not exclusively, to an event detection method, assembly, computer system and computer program product.

### BACKGROUND OF THE INVENTION

Artificial intelligence (AI) is developing rapidly and AI applications are supporting or will support all industries including the aerospace industry, agriculture, chemical industry, computer industry, construction industry, defense industry, education industry, energy industry, entertainment industry, financial services industry, food industry, health care industry, hospitality industry, information industry, manufacturing, mass media, mining, telecommunication industry, transport industry, water industry and direct selling industry.

The ability to monitor and/or to control systems is an area wherein AI can be very useful. Another area is the understanding of human behavior and interaction. In order to do that, AI systems should be able to detect and to recognize events in real-time. This requires smart approach using software, such as deep neural networks, and powerful computer hardware to execute computations within milliseconds.

Computer vision or machine vision is an area of AI wherein machine learning can be used to classify or to categorize scenes in images of living beings and objects. Computer vision is also a science that tries to understand what can be seen and what is happening in an image or series of images such as a photo picture, a video or a live stream. To that extend, machine learning can be used. An image contains a scene reflecting people, animals and/or objects showing a pose and often executing an activity.

Machine hearing is an area of AI wherein machine learning can be used to classify or to categorize sounds of living beings and objects. The technology allows a machine to selectively focus in a specific sound against many other competing sounds and background noise. This particular ability is called “auditory scene analysis”. Moreover, the technology enables the machine to segment several streams occurring at the same time. Many commonly used devices such as a smartphones, smart speakers, voice translators, and vehicle voice command systems make use of machine hearing.

AI systems may use computer vision and/or machine hearing to monitor and/or to control systems and to understand human behavior and interaction based on classification.

Using such AI systems as a monitoring tool requires such system to continuously process large amounts of data, e.g. images and/or sound data, including detecting and recognizing particular events in (near) real-time. Typically, such systems include software, such as deep neural networks, and powerful computer hardware to execute computations within milliseconds.

AI systems typically require lots of GPU and/or CPU processor power to process large amounts of data. This applies in particular to AI systems analyzing live video streams using computer vision technology for monitoring or surveilling people and places. The increase in data and associated costs to transport (e.g. streaming to the cloud) and process the data will grow exponentially with cameras, or in general image capturing devices, being installed everywhere and cameras being able to generate high-quality images (e.g. 4K images or more). The power consumption of GPU and/or CPU processors can be substantial and, in particular at full power, can cause overheating of the surrounding parts in a system.

The large amount of data are needed in order to allow an AI system to reliable determine events in a scene in a sequence of video frames. Trying to reduce the resource problem by simply reducing the amount of data will have unacceptable consequences for the reliability of the monitoring process. Reliability is often a crucial factor, in particular when a computer vision system is monitoring the safety of people. Hence, from the above it follows that there is a need in the art for improved event detection of events in a sequence of video images. In particular, there is a need in the art for improved methods and system for detecting and/or monitoring events in a view stream.

For example, US20210287014A1 according to its abstract describes “An activity assistance system includes a video camera arranged to acquire video of a person performing an activity, an output device configured to output human-perceptible prompts, and an electronic processor programmed to execute an activity script. The script comprises a sequence of steps choreographing the activity. The execution of each step includes presenting a prompt via the output device and detecting an event or sequence of events subsequent to the presenting of the prompt. Each event is detected by performing object detection on the video to detect one or more objects depicted in the video and applying one or more object-oriented image analysis functions to detect a spatial or temporal arrangement of one or more of the detected objects. Each event detection triggers an action comprising at least one of presenting a prompt via the output device and and/or going to another step of the activity script.”

US20210168372A1 according to its abstract describes “The present disclosure relates to encoding of video image using coding parameters, which are adapted based on events related to motion within the video image. Image content is captured by a standard image sensor and an event-triggered sensor, providing an event-signal indicating changes (e.g. amount and time-spatial location) of image intensity. Objects are detected within the video image, based on the event signal assessing motion of the object, and their textures extracted. The spatial-time coding parameters of the video image are determined based on the location and strength of the event signal, and the extent to which the detected objects moves.”

LEE SUNG Chun et al.: “Hierarchical abnormal event detection by real time and semi-real time multitasking video surveillance system”, Machine Vision and Applications, Springer Verlag, DE, vol. 25, No 1, 29 May 2013, in its abstract describes “In this paper, we describe how to detect abnormal human activities taking place in an outdoor surveillance environment. Human tracks are provided in real time by the base-line video surveillance system. Given trajectory information, the event analysis module will attempt to determine whether or not a suspicious activity is currently being observed. However, due to real-time processing constrains, there might be false alarms generated by video image noise or non-human objects. It requires further intensive examination to filter out false event detections which can be processed in an off-line fashion. We propose a hierarchical abnormal event detection system that takes care of real time and semi-real time as multi-tasking. In low level task, a trajectory-based method processes trajectory data and detects abnormal events in real time. In high level task, an intensive video analysis algorithm checks whether the detected abnormal event is triggered by actual humans or not.” This article describes a classical machine vision approach to event detection.

### SUMMARY OF THE INVENTION

The embodiments in this application aim to address problems related to the AI systems often requiring large amounts of GPU and/or CPU processor power to process large amount of data. In particular, the embodiments aim to address problems associated with the fact that continuous event monitoring of a sequence of images based on a deep learning process, e.g. a cloud-based deep learning process, is resource intensive in terms of bandwidth and/or processor (GPU) load. Transferring and processing large amounts of data that are necessary for a reliable inference processing requires lots of resources including computational power. The inference process requires large amounts of data because the reliability of inference process increases when more data, e.g. big data, is available. Therefore, using computer vision for monitoring images, e.g. a live video stream, over a long period of time or even 24/7 can be expensive or even impossible due to the lack of necessary resources.

In an aspect, the embodiments may relate to a event detection method for detecting a detail event in a time sequence of images having a main frame rate, the method comprising:
receiving a time slice of the time sequence of images;
storing in a memory a first set of images from the time slice at a first frame rate which is equal to or lower than the main frame rate;
providing a first inference engine comprising a first trained machine learning model which is trained for detecting a trigger event in an input comprising at least one image;
providing a second inference engine comprising a second trained machine learning model which is trained for detecting the detail event in an input comprising at least one image
processing a second set of images from the time slice at a second frame rate which is lower than the first frame rate, by providing at least one image of the second set of images as input to the first inference engine for detecting the trigger event in the second set of images;
upon detection of the trigger event in the second set of images, processing the first set of images from the memory by providing at least one image of the first set of images as input to the second inference engine for detecting the detail event.

There is further provided a method for detecting an event in a time sequence of images using a computing device, comprising:
receiving the time sequence of images;
storing the time sequence of images in a buffer;
processing a first set of images of the time sequence of stored images, by an inference engine, at a first sampling rate for detecting a first event in the first set of images, and
if the first event is detected, processing a second set of images of the time sequence of stored images, by an inference engine, at a second sampling rate for detecting a second event.

A sampling rate represents the number of images processed by a computer device within a certain time (t).

In an embodiment the forementioned methods can be built-in in a camera and therefore reduces the heating of the camera and can therefore prevent overheating of the camera.

There furthermore is provided an event detection assembly for detecting a detail event in a time sequence of images having a main frame rate, the assembly comprising:
an image detection device providing the time sequence of images at the main frame rate;
a computer memory for storing at least a time slice of said stream of images;
a data processor running a computer program, for preforming:
   receiving the time slice of the time sequence of images;
   storing in the computer memory a first set of images from the time slice and having a first frame rate which is equal to or lower than the main frame rate;
   providing a first inference engine comprising a first trained machine learning model which is trained for detecting a trigger event in an input comprising at least one image;
   providing a second inference engine comprising a second trained machine learning model which is trained for detecting the detail event in an input comprising at least one image;
   processing a second set of images from the time slice at a second frame rate which is lower than the first frame rate, by providing at least one image of the second set of images as input to the first inference engine for detecting the trigger event in the second set of images;
   upon detection of the trigger event in the second set of images, processing the first set of images from the memory by providing at least one image of the first set of images as input to the second inference engine for detecting the detail event.

In an embodiment, of the event detection assembly the computer program repeats receiving subsequent time slices from said stream of images.

In the current proposal, a time slice of the time sequence of images is used. In this respect, a time sequence of images relates to images that are captured in a time order. In mathematics, this is also referred to as a time series. The images can be placed in a time order. In Wikipedia®, this is defined as follows: “In mathematics, a time series is a series of data points indexed (or listed or graphed) in time order. Most commonly, a time series is a sequence taken at successive equally spaced points in time. Thus it is a sequence of discrete-time data. Examples of time series are heights of ocean tides, counts of sunspots, and the daily closing value of the Dow Jones Industrial Average.”. Often, the time intervals are equally spaced in time, but in the current proposal, it is not a requirement, though in specific embodiments, it can be advantageous.

A well-known time sequence of images is a movie. In a movie, a time interval between the time wherein images are captured is regular. Furthermore, usually the time interval between the capturing of images does not change. For instance, in a cinema movie, the images are usually displayed or projected with the same time interval as they were recorded or captured. Often, the capture rate and the projection rate are 60 frames per second. This is also expressed as a frame rate of 60 frames per second, fps. In surveillance cameras, often images are captured at a continuous frame rate, and this provides a nearly endless time sequence of images. From such a time sequence of images, one can take a part starting at a first time and ending at a second time, a little later than the first time. Such a part is here referred to as a time slice. In computer science, it may relate to a period to time a process in a multitasking system is allowed to run. Currently, is in fact a time sample having a start and end time. The length of the time slice does not have to be always be the same. In fact, in embodiments the actual length of a time slice may vary, and depend upon outcome of the applied operations.

Time slice as used in the current proposal thus is a time sample of a longer, often “endless” time sequence. It is thus not directly the “time slice” or “bullet time” referred to in a cinema movie. Though the current time slice may also be displayed it a much slower frame rate, thus having the effect of a frozen moment. In the current proposal the time slice can effectively be used at a much higher frame rate.

In an embodiment, the first set of images comprises at least one image which is not part of the second set of images. There are many possible options. For instance, the time slice can be at a frame rate, for instance 60 frames per second. The first set of images can be selected at a regular time base, for instance 10 frames per second. The second set can also be selected at a regular time base, for instance at an even lower frame rate, for instance 1 frame per second. The selection can be such that in the first set and the second set are all different images from the time slice. A non-regular time base selections may also be possible.

With respect to real-time, the term “near real-time” or “nearly real-time” (NRT), in telecommunications and computing, refers to the time delay introduced, by automated data processing or network transmission, between the occurrence of an event and the use of the processed data, such as for display or feedback and control purposes. For example, a near-real-time display depicts an event or situation as it existed at the current time minus the processing time, as nearly the time of the live event.

The distinction between the terms “near real time” and “real time” is somewhat nebulous and must be defined for the situation at hand. The term implies that there are no significant delays. In many cases, processing described as “real-time” would be more accurately described as “near real-time”. In fact, this may also be described as “functionally real-time”.

Near real-time also refers to delayed real-time transmission of voice and video. It allows playing video images, in approximately real-time, without having to wait for an entire large video file to download. Incompatible databases can export/import to common flat files that the other database can import/export on a scheduled basis so that they can sync/share common data in “near real-time” with each other.

Tolerable limits to latency for live, real-time processing is a subject of investigation and debate but is estimated to be between 6 and 20 milliseconds.

A real-time system has been described in Wikipedia as one which “controls an environment by receiving data, processing them, and returning the results sufficiently quickly to affect the environment at that time”. The term “real-time” is also used in simulation to mean that the simulation's clock runs at the same speed as a real clock, and in process control and enterprise systems to mean “without significant delay”.

The distinction between “near real-time” and “real-time” varies, and the delay is dependent on the type and speed of the transmission. The delay in near real-time is typically of the order of several seconds to several minutes.

Often, systems that are described or seen as “real-time” are functionally real-time.

In an embodiment, processing the first set of images is executed at a processing frequency which is equal to or lower than the first frame rate.

In an embodiment, the processing frequency is higher than the second frame rate.

In an embodiment, the first trained machine learning model is adapted for receiving as input a series of images from the second set of images. This may improve accuracy, certainty, or robustness of the result from the first trained machine learning model. It may be possible to use a cascade of machine learning models for training parts that together allow detection of an event. Furthermore, other artificial intelligence techniques may be combined, for instance case-based reasoning, and the like.

In another embodiment or further particular embodiment, the second trained machine learning model is adapted for receiving as input a series of images from the first set of images.

In an embodiment, all images of a time slice are stored in the memory for allowing a time delay for near real time processing of a first set of images and a second set of images. For instance, if the completion of a cycle that is needed to detect a trigger event, this allows the operation of main event detection to be performed without time gaps, which can be important in case of surveillance, or other tasks for which time gaps are not acceptable or lead to risks.

In an embodiment, the memory is implemented as a circular buffer for buffering a data stream of images, the memory having a memory capacity of one or multiple time slices of the time sequence of images. A circular buffer is an implementation which can implement a predictable time delay without leaving time gaps.

In an embodiment, when upon processing the second set of images no trigger event is detected, a first set of images from a new time slice is stored in a memory at a first frame rate which is equal to or lower than the main frame rate. This can for instance prevent time gaps.

In an embodiment, when upon processing the second set of images no trigger event is detected, a subsequent time slice is stored in the memory.

In an embodiment, when upon processing the first set of images no detail event is detected, a second set of images from a subsequent time slice is processed at a second frame rate which is lower than the first frame rate.

In an embodiment, the first and/or second inference engine is operationally coupled with respectively the first and/or second trained machine learning model. In an embodiment, the first inference engine is the second inference engine. In fact, one single inference engine may be used. Alternatively, the inference engine may be so versatile that it comprises several trained machine learning models that may be coupled using other logic, fuzzy logic, case based reasoning, or the like.

In an embodiment, the first machine learning model is the second machine learning model.

In an embodiment, the processing of the first and second inference engines are at a respective first and second inference rate, wherein the first and second inference rates are functionally equal to the respective first and second sample rate.

In an embodiment, the second trained machine learning model furthermore receives information regarding the trigger event as further input with the first set of images.

In an embodiment, a most recent time slice of the time sequence of images is stored, in particular the time slice including a functionally real time image.

There is further provided an event detection method for detecting an event in a time sequence of images having a main frame rate, the method comprising:
defining in the time sequence of images a first set of images comprising images from the time sequence at a first frame rate which is equal to or lower than the main frame rate;
defining in the time sequence of images a second set of images comprising images from the time sequence at a second frame rate which is lower than the first frame rate;
processing the second set of images by an inference engine at the second frame rate for detecting a trigger event in the second set of images, and upon detection of the trigger event,
processing the first set of images by an inference engine at the first frame rate for detecting the event.

There is further provided an event detection assembly for detecting an event in a time sequence of images having a main frame rate, the assembly comprising a computing device, a memory buffer, and at least one interference engine, the computing device comprising computer instructions which, when running on the computing device causes the computing device to perform the method described above.

In an embodiment, the event detection assembly further comprises an imaging device.

There is further provided a computer system for event detection, comprising:
a computer readable storage medium having computer readable program code embodied therewith, the program code including at least a trained deep neural network DNN, and
a processor, preferably a microprocessor, coupled to the computer readable storage medium,
wherein responsive to executing the first computer readable program code, the processor is configured perform to the method described above.

There is further provided a computer program product comprising software code portions configured for, when run in the memory of a computer, executing the method described above.

Embodiments include devices, methods, systems, and/or computer program products for running on a computing device to interpret a scene correctly while keeping the computational costs low. In particular, the embodiments are aimed at reducing computational costs of an inference system of e.g. a computer vision system by avoiding unnecessary inference of images when comparison between subsequent images in a sequence of images indicates that the images are similar. The computational costs of similarity detection between images is often significantly cheaper than inference of a scene in an image by an inference engine. Therefore, the current invention reduces monetary costs (e.g., cloud costs, CPU/GPU costs), energy consumption and latency required for processing data by an inference engine. The embodiments thus allow computer vision systems and AI based monitoring system become faster, use less energy and are cheaper to operate.

According for instance Wikipedia, it is explained: “In the field of artificial intelligence, an inference engine is a component of the system that applies logical rules to the knowledge base to deduce new information. The first inference engines were components of expert systems. The typical expert system consisted of a knowledge base and an inference engine. The knowledge base stored facts about the world. The inference engine applies logical rules to the knowledge base and deduced new knowledge. This process would iterate as each new fact in the knowledge base could trigger additional rules in the inference engine. Inference engines work primarily in one of two modes either special rule or facts: forward chaining and backward chaining. Forward chaining starts with the known facts and asserts new facts. Backward chaining starts with goals, and works backward to determine what facts must be asserted so that the goals can be achieved.”

In some embodiments, the sequence of images may be part of a video stream, which comprises visual data from which a series of images may be deducted. An image or a series of images or a time series of images can for instance result from a LIDAR, a visual light camera, a sonar imaging device, a radar imaging device, a laser imaging device, e.g. a laser scanner, or an infrared camera.

The multiple images can be processed sequentially. In an embodiment, the multiple images are processed parallel or semi-parallel. This allows near-real time of even real time processing.

In an embodiment when the AI system of a computer vision system is in a mode where it trains itself to a new particular task, while it is under the constraint that the training data should be anonymous, the system may detect that it can infer with certain probability the origin of the data. In this case, the system may switch itself to a mode where it “unlearns” its most recently gained knowledge.

An image may comprise or represent a scene including people, animals and/or objects associated with or in a pose and, often, executing an activity.

An image capturing device in an embodiment is a device that can provide an image or a series of images or a time series of images, in particular digital images or digital pictures. Such a device may comprise a camera of a filming (motion picture) device. Examples are devices comprising one or more image sensors, e.g. one or more CCDs, CMOS image sensors or similar imaging elements. Other examples of image capturing devices may include a 2D or 3D camera, a sonar, a radar, a laser, LIDAR, a 3D scanner, an infrared camera etc. As such, these devices are known to a skilled person.

An image captured by an image capturing device may comprise a collection of data points according to a certain data format. For example, an image may include pixels defining a 2D data format of pixel values, e.g. color values such as RGB pixel values, voxels defining a 3D data format of voxel values, a point cloud representing endpoints of vectors in a 3D reference frame and/or a 3D surface mesh.

A scene may be a view or picture of a place with at least one subject. A scene can be a view or picture of an event, or activity. Such a subject may be living being, i.e. an animal or a person, or an object. A physical product may be an example of an object, as is a car, a statue or a house. An activity in an embodiment is a series of actions. An action may be a movement of a subject having trajectory. A pose, as referred to in computer vision, may define a position and an orientation of a subject. A body of a living being has a pose. Also, a vehicle has a pose which can be defined by its position and orientation. The pose of a living being can be detected by articulated body pose estimation.

One or more computing devices may be used in the embodiments. A computing device may include any machine for automatically executing calculations or instructions.

In particular, a computing device may refer to any type of data processing hardware and may encompass all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computing device may include personal computer, a server system, a cloud server system, an edge server, a (locally) distributed server environment, a computer cloud environment or any circuitry for performing particular functions in an electronic device.

A computing device for implementing machine learning models can also include, for example, special-purpose hardware accelerator units for processing common and compute-intensive parts of machine learning training or production, i.e., inference, workloads.

The computing device may be configured to classify a scene or part of a scene in an image into one of a plurality of classes using a machine learning algorithm. In particular, the computing device may be configured to classify one or more subsets of data points (e.g. one or more sets of pixels in one or more areas of an image.

The computing device may be configured to execute a classification process for outputting one or more confidence values associated with one or more of the classes respectively. Further, in some embodiment, the computing device may be configured to determine a sub-scene, e.g. a region of interest (ROI), in the scene. In that case, the classification process may also be configured to classify a sub-scene.

In some embodiments, once the computing device determines a classification for one or more subsets of data points (e.g. one or more sets of pixels in one or more areas of an image), the computing device may store a given label associated with the determined class for the one or more subsets of data points data points. The data points may then become part of the training data which may be used for future determinations of scenes and sub-scenes.

The computing device may be configured to identify patterns using the machine learning algorithm to optimize sub-scene detection, and/or scene detection in general.

Classifying or categorizing is arranging (such as a group of people, things, poses, actions, events or a combination thereof) in classes or categories according to shared qualities or characteristics.

Classifying an event is the process of matching up an event to at least one class. In particular classifying an event is detecting the event and assigning it to one or multiple classes and possibly assigning a confidence level and/or probability for each class.

A class or category type is a catalog of one or more classes or categories of events that can be associated to one or more conditions, or to a description. If associated, the one or more conditions or description determine whether or not a class or category of events belongs to the class or category type.

The process of classifying something results in a classification.

A computer vision system uses computer vision to ‘look’ into a live video stream and uses artificial intelligence and machine learning to understand its content. When a living being appears in a live video stream, computer vision is used to classify the type of the living being, the pose of the living being, the action of the living being, the environment of the living being, and a combination thereof. Similar, when an action or event occurs in a live video stream, computer vision is used to classify the type of action or event, the environment of the action or event, and a combination thereof.

Classification may involve identifying to which of a set of classes (e.g. normal condition scene or emergency scene and/or allowed action or prohibited action and/or awkward pose or normal pose and/or ordinary object or out-of-the-ordinary object) a new captured scene may belong, on the basis of a set of training data with known classes, such as the aforementioned classes. Classification of the one or more subsets of data points associated with a captured scene may be performed using one or more machine learning algorithms and statistical classification algorithms.

Example algorithms may include linear classifiers (e.g. Fisher's linear discriminant, logistic regression, naive Bayes, and perceptron), support vector machines (e.g. least squares support vector machines), clustering algorithms (e.g. k-means clustering), quadratic classifiers, multi-class classifiers, kernel estimation (e.g. k-nearest neighbour), boosting, decision trees (e.g. random forests), neural networks, Gene Expression Programming, Bayesian networks, hidden Markov models, binary classifiers, and learning vector quantization. Other example classification algorithms are also possible. In the current proposal, reference is made to a machine learning model. Wikipedia® defines this “Machine learning (ML) is the study of computer algorithms that can improve automatically through experience and by the use of data. It is seen as a part of artificial intelligence. Machine learning algorithms build a model based on sample data, known as training data, in order to make predictions or decisions without being explicitly programmed to do so.”. Usually, it is based upon an artificial neural network. When is has multiple layers, it can be referred to as a “deep learning model”. Again, Wikipedia defines “Deep learning (also known as deep structured learning) is part of a broader family of machine learning methods based on artificial neural networks with representation learning. Learning can be supervised, semi-supervised or unsupervised.”

The process of classification may involve the computing device determining, based on the output of the comparison of the one or more subsets with the one or more predetermined sets of scene types, a probability distribution (e.g. a Gaussian distribution) of possible scene types associated with the one or more subsets. Those skilled in the art will be aware that such a probability distribution may take the form of a discrete probability distribution, continuous probability distribution, and/or mixed continuous-discrete distributions. Other types of probability distributions are possible as well.

In order to detect and localize a subject in a scene from a captured image an embodiment uses a method to detect subjects. Such a method will use machine learning techniques (in particularly deep learning) to design and train a model which detects subjects given an input of a visual representation, e.g. an RGB image, as the system perceives. The model is trained on a large amount of annotated data; it comprises images with and without subjects and locations of the subjects are annotated.

In order to detect and localize a living being in a scene from a retrieved image an embodiment uses a method to detect living beings. Such a method will use machine learning techniques (in particularly deep learning) to design and train a model which detects living beings given an input of a visual representation, e.g. an RGB image, as the system perceives. The model is trained on a large amount of annotated data; it comprises images with and without living beings and locations of the living beings are annotated.

In the case of deep learning, a detection framework such as Faster-RCNN, SSD, R-FCN, Mask-RCNN, or one of their derivatives can be used. A base model structure can be VGG, AlexNet, ResNet, GoogLeNet, adapted from the previous, or a new one. A model can be initialized with weights and trained similar tasks to improve and speedup the training. Optimizing the weights of a model, in case of deep learning, can be done with the help of deep learning frameworks such as Tensorflow, Caffe, or MXNET. To train a model, optimization methods such as Adam or RMSProb can be used. Classification loss functions such Hinge Loss or Softmax Loss can be used. Other approaches which utilize handcrafted features (such as LBP, SIFT, or HOG) and conventional classification methods (such as SVM or Random Forest) can be used.

To detect bodily features, the system in an embodiment can determine key points on the body (e.g. hands, legs, shoulders, knees, etc.) of a living being.

To detect the key points on the body of a living being, in an embodiment the system comprises a model that is designed and trained for this detection. The training data to train the model comprises an annotation of various key points locations. When a new image is presented, the model allows identification of the locations of such key points. To this end, the system can utilize existing key point detection approaches such as MaskRCNN or CMU Part Affinity Fields.

The training procedure and data can be customized to best match the context of the content of the retrieved images. Such context may comprise an indoor context (like a home, a shop, an office, a station, an airport, a hospital, a theatre, a cinema etc.) or an outdoor context (like a beach, a field, a street, a park etc.) wherein there are changing lighting conditions.

For example, a pretrained deep neural network (DNN) on ImageNet, e.g. VGGNet, AlexNet, ResNet, Inception and Xception, can be adapted by taking the convolution layers from these pretrained DNN networks, and on top of them adding new layers specially designed for scene recognition comprising one or more display devices, and train the network as described for the model. Additional new layers could comprise specially designed layers for action and pose recognition. All the aforementioned layers (scene recognition, pose and action recognition) can be trained independently (along with/without the pre-trained conventional layers) or trained jointly in a multi-task fashion.

As mentioned above, artificial intelligence (AI) and in particularly computer vision is developing rapidly and an embodiment of a system according the invention can be integrated or used in applications that are supporting or will support all industries including the aerospace industry, agriculture, chemical industry, computer industry, construction industry, defense industry, education industry, energy industry, entertainment industry, financial services industry, food industry, health care industry, hospitality industry, information industry, manufacturing, mass media, mining, telecommunication industry, transport industry, water industry and direct selling industry.

An embodiment of a system according the invention can be applied to and integrated in many different larger systems. An embodiment of a system according the invention can be physically integrated in such a larger system, or it can be functionally coupled to such a larger system. For instance, an embodiment of a system according the invention can be part of a vehicle, a plane, a boat, part of an energy plant, part of a production facility, part of a payment system, a drone or a robotic system.

The ability to monitor and control systems is an area wherein computer vision can be very useful. Another area is the understanding of human behavior and interaction. Therefore, computer vision systems in an embodiment are used to detect and to recognize events in real-time. This requires a smart approach using software, such as deep neural networks, and powerful computer hardware to execute computations within milliseconds. In the current computer vision system, a trained neural network can be used.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The term “substantially”, if used, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Embodiments of the subject matter described in this specification can be implemented in a computing device that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing device can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

The devices or apparatus herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device or apparatus claims enumerating several means, several of these means may be embodied by one and the same item of hardware. The mere fact that certain measures are recited in mutually different dependent claims does not indicate that a combination of these measures cannot be used to advantage.

The invention further applies to an apparatus or device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A-1E depict an embodiment of detecting a missed event.

FIG. 2 depicts example FIG. 1 as a time slice of a time sequence of images.

FIG. 3 depicts a flow chart of a method of a further example.

The drawings are not necessarily on scale.

### DESCRIPTION OF PREFERRED EMBODIMENTS

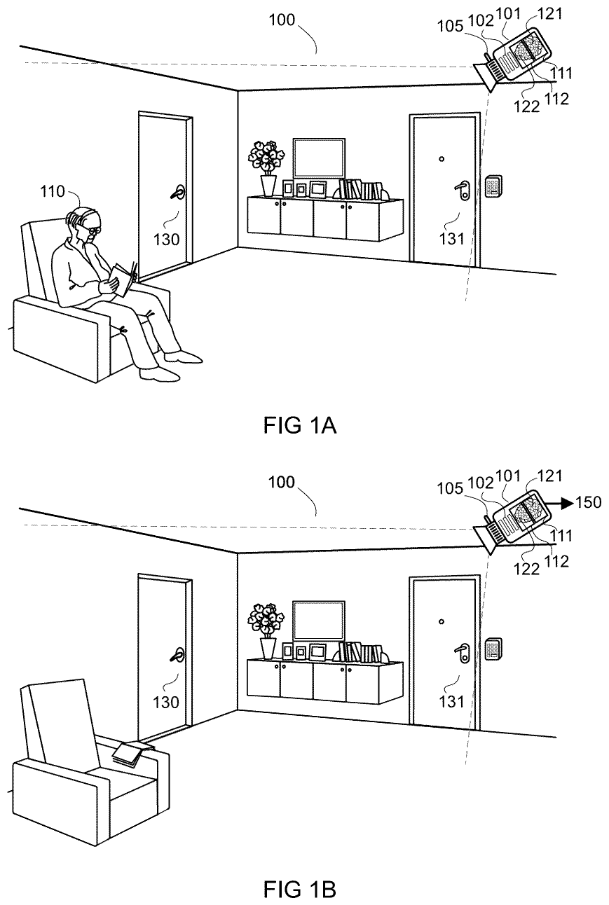

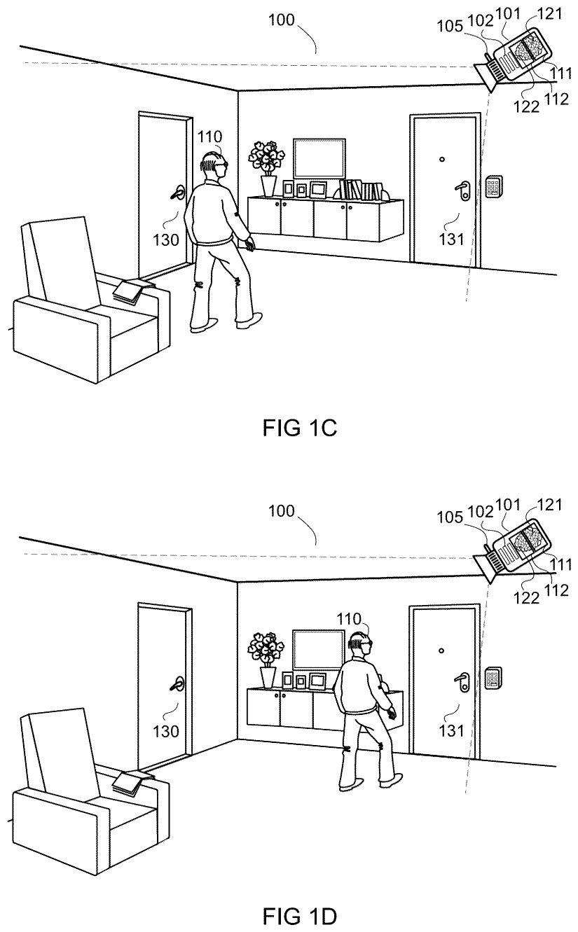

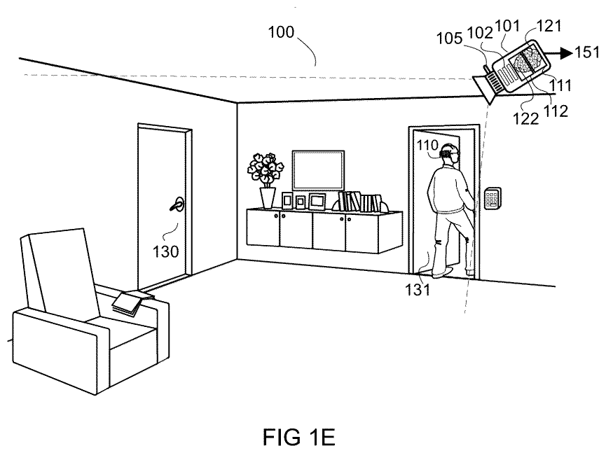

FIGS. 1A-E depict an example of detecting of a first or trigger event 150 and a missed or detail event 151 by a computer device 101. This computer device is operationally coupled to a memory 102, and a first inference engine 111 comprising a first trained machine learning model 121, and a second inference engine 112 comprising a second trained machine learning model 122. It receives a sequence of images from camera 105. This sequences usually is a time sequence. In most cases, the time between two images is a constant, but can be set in a camera before or during receiving images. This is indicated as a frame rate and can be measured in ‘frames per second’, or fps. If a time between two images is T, that the fps=1/T. A time sequence of images may be a sequence of video frames consisting of different frame type (or picture types), such as I-frames, P-frames and B-frames. Therefore images can be equivalent to frames. Therefore, the terms “frame”, “image”, “video image” and “video frame” can be interchangeable herein.

In the current example, the trigger event 150 relates to a person 110 that is not visible in a room 100 anymore. The detail event 151 shows how person 110 left the room 100 through a door 131 instead of a door 130.

FIG. 1A depicts room 100 being monitored by camera 105 in which a person 110 is present in room 100, and illustrates a pose; e.g. person 110 is reading a book. The computer device 101 receives a time sequence of images from camera 105 at a main frame rate. Computer device 101 receives a time slice of the time sequence of images. It then stores in a memory 102 a first set of images from the time slice at a first frame rate which is equal or lower than the main frame rate. It processes a second set of images from the time slice at a second frame rate which is lower than the first frame rate, by providing at least one image of the second set of images as input to the first inference engine 111 for detecting the trigger event 150 in the second set of images, while using the first trained machine learning model 121.

FIG. 1B depicts room 100 while it is being monitored by camera 105. Person 110 is not present in room 100 anymore. Computer device 101 has processed the at least one image of the second set of images, and the trigger event 150 is detected which can for instance be phrased as “person 110 not visible in room 100” or “no person in the room”. Please note that the event does not need to be expressed in words.

FIG. 1C is now depicting an image from the first set of images, illustrating an activity of person 110 that is walking. After and/or upon the detection of the trigger event 150 in the second set of images, computer device 101 processes the first set of images from memory 102. It provides at least one image of the first set of images as input to the second inference engine 112 for detecting the detail event 151, while using the second trained machine learning model 122.

FIG. 1D is also depicting an image from the first set of images, illustrating an activity of person 110 that is walking towards door 131, and wherein computer device 101 is still processing the first set of images from memory 102.

FIG. 1E is still depicting an image from the first set of images, illustrating
an activity of person 110 that is leaving room 100. Computer device 101 has processed images of the first set of images from memory 102, and the detail event 151 is detected i.e., for instance represented as “person 110 going through door 131”.

By combining trigger event 150 and detail event 151 a further event can be inferred i.e. “person 110 left room 100 through door 131”. The inference engine may have concatenated the two events into a sentence or another indication. It here concatenated it into one main event.

In this embodiment the second set of images comprises at least one image which is not part of the first set of images.

In an embodiment processing the first set of images is executed at a processing frequency which is equal to or lower than a first frame rate.

In a further embodiment the processing frequency is higher than a second frame rate.

These variations allow saving of computer processing time, data transmission, storage space, and the like. Thus, responses may be quicker, and or energy is saved. It may be possible to contact medical staff quicker as less data is processed. It can also prevent time gaps in surveillance.

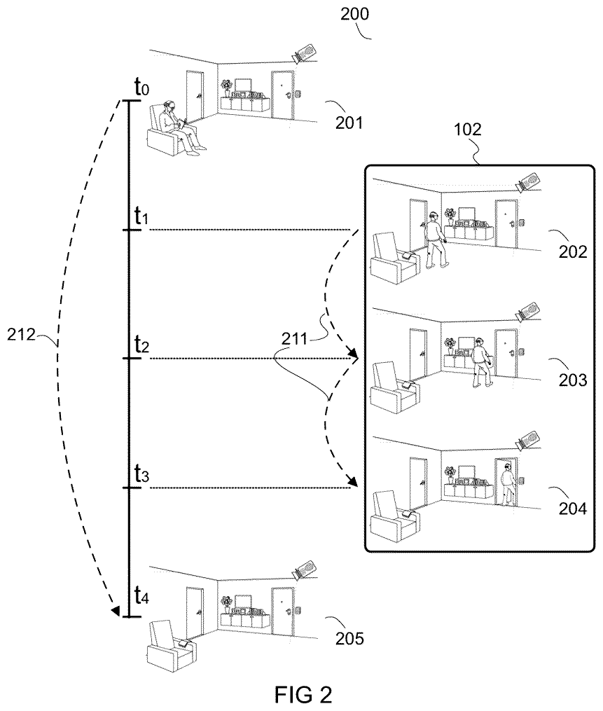

FIG. 2 depicts the example of FIG. 1A-E as a time slice of a time sequence of images (201-205). FIG. 2 represents the time slice of 5 seconds wherein camera 105 provides a time sequence of images at a main frame rate of 1 image per second, or 1 fps, in a time slot starting at a time to and ending at a time t₄.

The first set of images is stored in memory 102 at a first frame rate 211 with a frequency of 1 image per second, or 1 fps, in a time slot starting at a time t₁ and ending at a time t₃, comprising images 202, 203 and 204.

The second set of images is processed at a second frame rate 212 with a frequency of 1 image per 4 seconds, or 0.25 fps, at a time t₁ and at a time t₄, comprising images 201 and 205.

At time t₄ the first or trigger event “person not visible in room” (150) is detected.

After and/or upon the detection of this trigger event 150 in the second set of images (201 and 205), the first set of images (202, 203 and 204) from memory 102 is processed at a processing frequency which is equal to the first frame rate 211.

The processing frequency is the number images in a set of images representing a time slice that is processed with or in a duration of one second. The processing of this time slice usually takes only a fraction of second, in many cases only a few milliseconds. Thus, the time slice may for instance represent two seconds of captured images, the processing of these images may take milliseconds.

In image 204 the detail event “person going through door” (151) is detected.

This example illustrates that a processing frequency, lower than the first frame rate 211, for instance with a frequency of 1 image per 2 seconds, or 0.5 fps, would still be adequate to detect the detail event “person going through door” (151) in image 204. After all, in this case one can skip the processing of image 203 in the first set of images, since only in image 204 the predefined detail event 151 can be detected.

In an embodiment processing the first set of images from memory 102 can be executed by providing the full, complete first set of images (202, 203 and 204) at once as input to the second inference engine 112 for detecting the detail event 151.

In a further embodiment all images of a time slice are being stored in memory allowing a time delay or near real time processing of a first set of images and a second set of images. In addition, memory can be implemented as a circular buffer for buffering a data stream of images, having a memory capacity of one or multiple time slices comprising a time sequence of images.

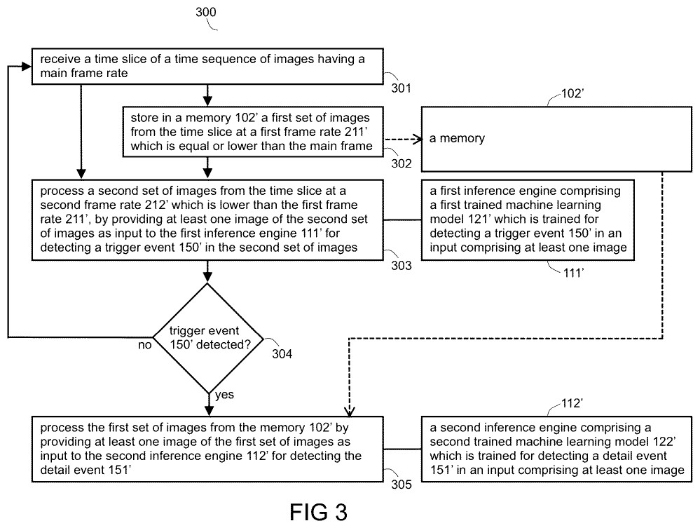

FIG. 3 depict a flow chart of a further example method 300 to detect a detail event in a time sequence of images having a main frame rate.

The method 300 may include one or more operations, functions, or actions as illustrated by one or more of blocks 301-305 and may use one or more components as illustrated by one or more of block 102′ (memory of this further example) and blocks 111′-112′ (respectively first- and second inference engine of this further example). Although these blocks are illustrated in a sequential order, these blocks may in some instances be performed in parallel. Also, the various blocks may be combined into fewer blocks, divided into additional blocks, and/or removed based upon the desired implementation.

In addition, for the method 300, and other processes and methods disclosed herein, the flow chart shows functionality and operation of one possible implementation of present embodiments. In this regard, each block may represent a module, a segment, or a portion of program code, which includes one or more instructions executable by data a processor for implementing specific logical functions or steps in the process. The computer program product may be stored on any type of computer readable medium or memory, for example, such as a storage device including a disk or hard drive.

In addition, for the method 300, and other processes and methods disclosed herein, each block in FIG. 3 may represent circuitry that is wired to perform the specific logical functions in the process. For the sake of example, the method 300 show in FIG. 3 will be described as implemented by an example computer program product such as the computer program product. The method 300 can also be described as implemented by a camera or computing device, as the computing device and the computer program product may be onboard the camera, as illustrated by camera 105 (FIGS. 1A-1E), or may be off-board but in wired or wireless communication with the camera. Therefore, the terms “computer device”, “computer program product” and “camera” can be interchangeable herein. It should be understood that other entities or combinations of entities can implement one or more steps of the example method 300.

At block 301, the method 300 includes: receive a time slice of a time sequence of images having a main frame rate.

At block 302, the method 300 includes: store in a memory 102′ a first set of images from the time slice at a first frame rate 211′ which is equal or lower than the main frame.

At block 303, the method 300 includes: process a second set of images from the time slice at a second frame rate 212′ which is lower than the first frame rate 211′, by providing at least one image of the second set of images as input to the first inference engine 111′ for detecting a trigger event 150′ (in this further example) in the second set of images.

At block 304, the method 300 includes: a trigger event
150′ detected? When “yes”, upon detection of the trigger event 150′ in the second set of images, the method 300 continues at block 305. When “no”, there is no detection of the trigger event 150′ in the second set of images, the method 300 continues at block 301.

At block 305, the method 300 includes: process the first set of images from the memory 102′ by providing at least one image of the first set of images as input to the second inference engine 112′ for detecting the detail event 151′ (in this further example).

In furthermore examples, the first trained machine learning model 121′ and/or the second trained machine learning model 122′ should be illustrated in a separate trained-machine-learning-model block. Either in one separate block (both trained machine learning models are the same) or in 2 separate blocks, one block for each trained machine learning model. These trained-machine-learning-model blocks can either be depicted inside the blocks (111′-112′) of the inference engines or depicted outside the blocks (111′-112′) of the inference engines and be operational coupled to the blocks (111′-112′) of the inference engines.

As a result, the first and/or second inference engine can be operationally coupled with respectively the first and/or second trained machine learning model and/or both.

In another example, the first inference engine is the second inference engine, and the inference engine blocks (111′-112′) should be combined.

An inference engine is usually software implemented. It receives input and provides it as input to one or more trained machine learning models. The result of applying the one or more machine learning models on that input is provided as output from the inference engine. An inference engine can comprise additional logic to be applied on either the input, the result or both.

For detecting a trigger event, in for instance the examples explained above, a neural network can (here, the second neural network) for instance be trained using a filmed room with one or more persons, people coming into the room en leaving the room. In the training- and test set, for images or sets of images, in the training set it can for instance be indicated if a person left the room or entered the room. In this way, a neural network can be trained to categorize if one or more images have: the same amount of people, or people left the room or people entered the room.

The first neural network can be trained, for instance to categorized where a person left to, which door did the person take. Does the same person return, or that network may recognize which person. For this again video footage con be used taken in the same room, and events in the room can be classified first and thus a trainingsset and testset can be created.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Starting from this disclosure, many more embodiments will be evident to a skilled person. These embodiments are within the scope of protection and the essence of this invention and are obvious combinations of prior art techniques and the disclosure of this patent.

1. An event detection method for detecting a detail event in a time sequence of images having a main frame rate, the method comprising:
receiving a time slice of the time sequence of images;
storing in a memory a first set of images from the time slice and having a first frame rate which is equal to or lower than the main frame rate;
providing a first inference engine comprising a first trained machine learning model which is trained for detecting a trigger event in an input comprising at least one image;
providing a second inference engine comprising a second trained machine learning model which is trained for detecting the detail event in an input comprising at least one image;
processing a second set of images from the time slice and having a second frame rate which is lower than the first frame rate, by providing at least one image of the second set of images as input to the first inference engine for detecting the trigger event in the second set of images;
upon detection of the trigger event in the second set of images, processing the first set of images from the memory by providing at least one image of the first set of images as input to the second inference engine for detecting the detail event.

2. The method of claim 1, wherein the first set of images comprises at least one image which is not part of the second set of images.

3. The method of claim 1, wherein processing the first set of images is executed at a processing frequency which is equal to or lower than the first frame rate.

4. The method of claim 1, wherein the processing frequency is higher than the second frame rate.

5. The method of claim 1, wherein the first trained machine learning model is adapted for receiving as input a series of images from the second set of images, and/or wherein the second trained machine learning model is adapted for receiving as input a series of images from the first set of images.

6. The method of claim 1, wherein all images of a time slice are stored in the memory for allowing a time delay for near real time processing of a said first set of images and a said second set of images, in particular wherein the processing the second set of images starts directly after said time slice is stored in the memory.

7. The method of claim 1, wherein the memory is implemented as a circular buffer for buffering a data stream of images, the memory having a memory capacity of one or multiple time slices of the time sequence of images.

8. The method of claim 1, wherein if upon processing the second set of images no trigger event is detected, then a first set of images from a new time slice is stored in a memory at a first frame rate which is equal to or lower than the main frame rate, in particular wherein the new time slice is a subsequent time slice that is stored in the memory.

9. The method of claim 1, wherein if upon processing the first set of images no detail event is detected, then a said second set of images from a subsequent time slice is processed at a said second frame rate which is lower than the first frame rate.

10. The method of claim 1, wherein the first and second inference engine is operationally coupled with respectively the first and second trained machine learning model.

11. The method of claim 1, wherein the first inference engine is the second inference engine, and/or wherein the first machine learning model is the second machine learning model.

12. The method of claim 1, wherein the processing of the first and second inference engines are at a respective first and second inference processing rate, wherein the first and second inference processing rates are functionally equal to the respective first and second sample rate.

13. The method of claim 1, wherein the second trained machine learning model furthermore receives information regarding the trigger event as input in addition to the first set of images.

14. The method of claim 1, wherein the most recent time slice of the time sequence of images is stored, in particular the most recent time slice includes a functionally real time image.

15. The method of claim 1, wherein said method is repeated each time using a next, subsequent time slice from said time sequence of images.

16. The method of claim 1, wherein said method is repeated each time using a next, subsequent time slice from said time sequence of images, with said next time slice overlapping said time slice with at least one image.

17. The method of claim 1, wherein said second inference engine receives as input said second set of images, and said first inference engine receives as input said first set of images.

18. An event detection assembly for detecting an event in a time sequence of images having a main frame rate, the assembly comprising a computing device, a memory buffer, and at least one interference engine, the computing device comprising computer instructions which, when running on the computing device causes the computing device to perform an event detection method for detecting a detail event in a time sequence of images having a main frame rate, the method comprising:
receiving a time slice of the time sequence of images;
storing in a memory a first set of images from the time slice and having a first frame rate which is equal to or lower than the main frame rate;
providing a first inference engine comprising a first trained machine learning model which is trained for detecting a trigger event in an input comprising at least one image;
providing a second inference engine comprising a second trained machine learning model which is trained for detecting the detail event in an input comprising at least one image;
processing a second set of images from the time slice and having a second frame rate which is lower than the first frame rate, by providing at least one image of the second set of images as input to the first inference engine for detecting the trigger event in the second set of images;
upon detection of the trigger event in the second set of images, processing the first set of images from the memory by providing at least one image of the first set of images as input to the second inference engine for detecting the detail event.

19. An event detection assembly for detecting a detail event in a time sequence of images having a main frame rate, the assembly comprising:
an image detection device providing the time sequence of images at the main frame rate;
a computer memory for storing at least a time slice of said stream of images;
a data processor running a computer program, for preforming:
receiving the time slice of the time sequence of images;
storing in the computer memory a first set of images from the time slice and having a first frame rate which is equal to or lower than the main frame rate;
providing a first inference engine comprising a first trained machine learning model which is trained for detecting a trigger event in an input comprising at least one image;
providing a second inference engine comprising a second trained machine learning model which is trained for detecting the detail event in an input comprising at least one image;
processing a second set of images from the time slice at a second frame rate which is lower than the first frame rate, by providing at least one image of the second set of images as input to the first inference engine for detecting the trigger event in the second set of images;
upon detection of the trigger event in the second set of images, processing the first set of images from the memory by providing at least one image of the first set of images as input to the second inference engine for detecting the detail event.

20. The event detection assembly of claim 19, wherein said computer program repeats receiving subsequent time slices from said stream of images.

21. A non-transitory computer readable medium having stored thereon computer program instructions that, when executed by a processor in a computing device, configure the computing device to perform the method of claim 1.
